(19) United States
(12) Patent Application Publication
(10) Pub. No.: US 2011/0148789 A1
(43) Pub. Date: Jun. 23, 2011

(54) MOBILE DEVICE HAVING PROJECTOR MODULE AND METHOD FOR OPERATING THE SAME

(75) Inventors: Hee Woon KIM, Suwon-si (KR); Si Hak JANG, Yongin-si (KR)

(73) Assignee: SAMSUNG ELECTRONICS CO. LTD., Suwon-si (KR)

(21) Appl. No.: 12/953,847

(22) Filed: Nov. 24, 2010

(30) Foreign Application Priority Data
Dec. 18, 2009 (KR) 10-2009-0126551

(51) Int. Cl. G06F 3/041; G09G 5/00

(52) U.S. Cl. 345/173; 345/156

(57) ABSTRACT

A mobile device and a method for operating the same to allow a more efficient projecting of data and a more effective control of the projected data are provided. The mobile device includes a projector module, a sensor unit, and a control unit. The projector module outputs an image outwardly. The sensor unit having at least one sensor is activated when the projector module is activated. The sensor unit detects a state of the mobile device and then outputs a sensor signal. The control unit controls the image outputted through the projector module, depending on the sensor signal.

### PRIORITY

This application claims the benefit under 35 U.S.C. §119(a) of a Korean patent application filed on Dec. 18, 2009 in the Korean Intellectual Property Office and assigned Serial No. 10-2009-0126551, the entire disclosure of which is hereby incorporated by reference.

### BACKGROUND OF THE INVENTION

1. Field of the Invention

The present invention relates to a mobile device. More particularly, the present invention relates to a mobile device having both a projector module and a sensor unit and also a method for operating the mobile device to allow a more efficient projecting of data and a more effective control of the projected data.

2. Description of the Related Art

A great variety of mobile devices have been developed and introduced recently. Rapid advances in mobile communication technologies are investing traditional mobile devices with many useful applications that meet customers' demands. Accordingly, users of mobile devices today come to use information in various forms of voice, text, graphic, etc. and to enjoy music, broadcast, game, etc.

Such mobile devices, however, have inherent limitations in the size of their display unit. This may restrict the capability of representing output data such as images or videos on the size-limited display unit. Accordingly, a projector module is sometimes employed for such mobile devices. This internal projector module of a mobile device magnifies output data and then projects the output data onto an external display screen or other surface. A user of a mobile device with such a projector module can see output data on a sufficiently large-sized external display screen instead of a small-sized internal display unit of the mobile device.

However, mobile devices equipped with a projector module have only recently been developed. As a result, such a mobile device is short of functions available for user's convenience in connection with a projector module. Accordingly, an improvement in function of a mobile device having a projector module is desired.

### SUMMARY OF THE INVENTION

An aspect of the present invention is to address at least the above-mentioned problems and/or disadvantages and to provide at least the advantages described below. Accordingly, an aspect of the present invention is to provide an easier and simpler control technique for a mobile device having a projector module.

According to an aspect of the present invention, a mobile device is provided. The device includes a projector module for projecting an image onto an external surface, a sensor unit including at least one sensor configured to be activated when the projector module is activated, for detecting a state of the mobile device, and for outputting a sensor signal, and a control unit for controlling the image projected through the projector module, based on the sensor signal.

According to another aspect of the present invention, a method for operating a mobile device having a projector module is provided. The method includes activating the projector module, activating a sensor unit that includes at least one sensor for detecting a state of the mobile device, projecting through the projector module an image corresponding to specific content selected at a user's request, and performing an output control of the image projected through the projector module, based on a given sensor signal produced in the sensor unit.

According to another aspect of the present invention, a method of operating a mobile device having a projector module is provided. The method includes enabling at least one sensor of a sensor unit when the projector module of the mobile device is activated, projecting content onto an external surface via the projector module, and when the at least one enabled sensor generates a sensor signal, controlling the projection of the image and/or a displaying of data on a display unit of the mobile device, based on the sensor signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram which illustrates the configuration of a mobile device in accordance with an exemplary embodiment of the present invention;

FIG. 2 is a block diagram which illustrates the configuration of a control unit according to an exemplary embodiment of the present invention;

FIG. 3 is an example view which illustrates a user interface of a mobile device in accordance with an exemplary embodiment of the present invention;

FIG. 4 is an example view which illustrates a user interface of a mobile device in accordance with an exemplary embodiment of the present invention;

FIG. 5 is an example view which illustrates a user interface of a mobile device in accordance with an exemplary embodiment of the present invention;

FIG. 6 is an example view which illustrates a user interface of a mobile device in accordance with an exemplary embodiment of the present invention; and

FIG. 7 is a flow diagram which illustrates a method for operating a mobile device having a projector module in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention defined by the claims and their equivalents. It includes various specific details to assist in that understanding, but these are to be regarded as merely exemplary. Accordingly, those skilled in the art recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

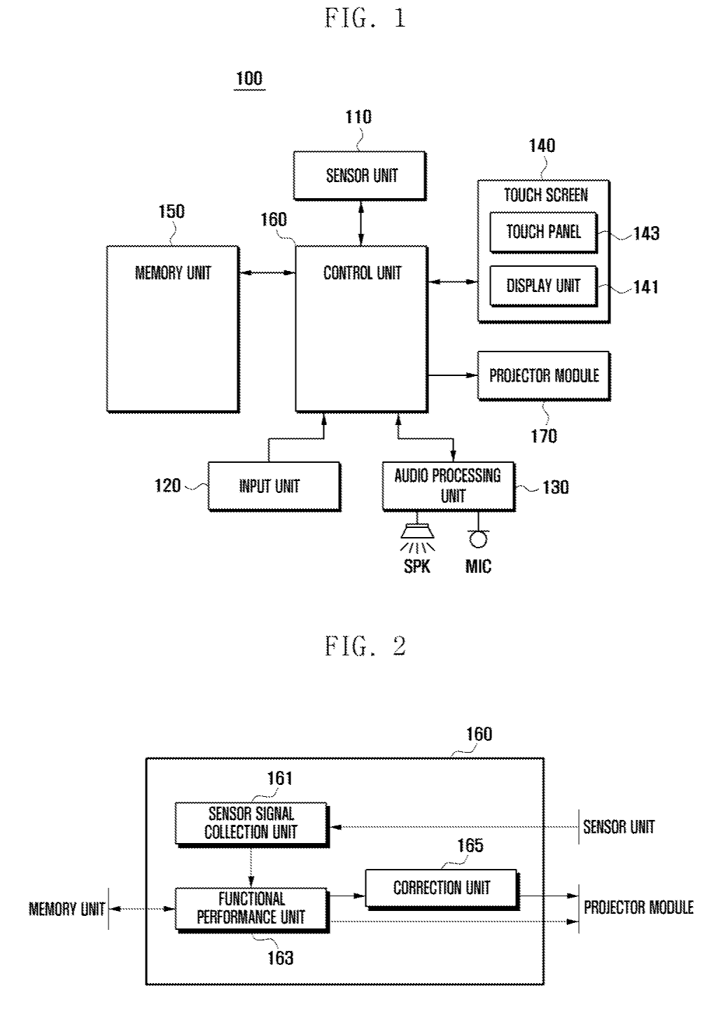

FIG. 1 is a block diagram which illustrates the configuration of a mobile device in accordance with an exemplary embodiment of the present invention.

Referring to FIG. 1, the mobile device 100 includes a sensor unit 110, an input unit 120, an audio processing unit 130, a touch screen 140, a memory unit 150, a projector module 170, and a control unit 160. The touch screen 140 has a display unit 141 and a touch panel 143. In some cases, the mobile device 100 may further include a Radio Frequency (RF) unit.

The mobile device 100 controls output data of the display unit 141 and of the projector module 170, depending on a sensor signal produced in the sensor unit 110. The mobile device 100 supports performing a play, pause, fast-forward, rewind, stop, function shift, etc. of output data projected through the projector module 170, depending on a sensor signal of the sensor unit 110.

The sensor unit 110 includes various kinds of sensors, such as an acceleration sensor, a gyro sensor, a pressure sensor, a vibration sensor, and a geomagnetic sensor. These sensors operate when electric power is supplied under the control of the control unit 160, produce particular signals in response to the movement of the mobile device 100, the pressure applied to the mobile device 100, or the like, and deliver the signals to the control unit 160. The sensor unit 110 may be activated when the projector module 170 operates based on a sensor signal. The mobile device 100 offers a sensor mode and, when the user selects the sensor mode, activates the sensor unit 110. The sensor mode may be initiated automatically when the projector module 170 is activated, or may be initiated manually through the user's setting. Various sensors of the sensor unit 110 may be installed on or within a body of the mobile device 100 and also may produce sensor signals according to a particular position, pose, or state of the mobile device 100.

The input unit 120 includes a plurality of input keys and function keys which are provided to receive the user's input. The function keys may have navigation keys, side keys, shortcut keys, and various other special keys. The input unit 120 creates various key signals in association with the user's selection or commands and delivers them to the control unit 160. The input unit 120 may be formed of a QWERTY keypad, a 3*4 keypad, a 4*3 keypad, etc., each of which has a plurality of keys. In some exemplary embodiments, the input unit 120 may be omitted and replaced with a key map displayed on the touch screen 140 if the touch screen 140 is made in the form of a full touch screen. The input unit 120 may create an input signal for activating the projector module 170, an input signal for selecting content to be outputted through the projector module 170, and an input signal for regulating the outputted content, depending on the user's manipulation, and send the input signal to the control unit 160.

The audio processing unit 130 has a speaker (SPK) for outputting audio data and a microphone (MIC) for receiving audio signals. When content stored in the memory unit 150 is played, the audio processing unit 130 may output audio data contained in the played content through the speaker (SPK). Accordingly, while visible data of selected content is outputted through the projector module 170, the audio processing unit 130 may output audible data (e.g., background music) of the selected content.

The touch screen 140 includes the display unit 141 and the touch panel 143. Typically the touch panel 143 is disposed at the front of the display unit 141, but this arrangement is not required. The size of the touch screen 140 may depend on that of the touch panel 143.

The display unit 141 represents a variety of information inputted by the user or offered to the user, including various menu pages of the mobile device 100. For instance, the display unit 141 may visually output an idle screen, a menu screen, a message writing screen, a call screen, and the like. The display unit 141 may be formed of a Liquid Crystal Display (LCD), an Organic Light Emitting Diode (OLED), or any other equivalent. The display unit 141 may output a screen of the same content as projected through the projector module 170. In this case, the size of a screen outputted on the display unit 141 may vary according to the size and ratio of the display unit 141. The display unit 141 may output a screen that is different from a screen projected through the projector module 170. For example, when an image of specific content is projected through the projector module 170, the display unit 141 may not only output the content image according to an input signal of the input unit 120 or a sensor signal of the sensor unit 110, but may also output one of various menu screens required for controlling a play of content. Additionally, the display unit 141 may output such a menu screen only without outputting the content image projected through the projector module 170.

The touch panel 143 is configured to cover the display unit 141. The touch panel 143 creates a touch event in response to the touch or approach of an object such as a user's finger and then delivers the created touch event to the control unit 160. The touch panel 143 may be arranged in the form of a matrix and, when a specific touch event occurs thereon, sends information about the location and type of the touch event to the control unit 160. The control unit 160 checks the received information about the location and type of the touch event, checks specific image data such as a key map or menu map mapped to the location of the touch event, and performs a particular function linked to the image data. The touch panel 143 may be deactivated under the control of the control unit 160. For example, when a sensor mode is initiated to activate the projector module 170, the touch panel 143 may be deactivated. When a given sensor signal is received in the sensor mode, for example, in response to a pressure more than a given value being detected by a piezoelectric sensor, the touch panel 143 may be deactivated. This setting function for a user to deactivate the touch panel 143 may be offered in the form of a menu by the mobile device 100.

The memory unit 150 stores a variety of applications required for performing particular functions according to exemplary embodiments of the present invention. The memory unit 150 may store specific applications suitable for playing various content files, and a key map or menu map used for the operation of the touch screen 140. The key map may be one of various well known types such as a keyboard map, a 3*4 key map, a QWERTY key map, etc. and also may be a special control key map suitable for the operation of a specific application in use. The menu map may have several menu items offered by the mobile device 100 and also may be a special menu map suitable for controlling the operation of a specific application in use. The memory unit 150 may include a program region and a data region.

The program region may store an Operating System (OS) for booting the mobile device 100 and operating the above-mentioned respective elements, and specific applications for supporting various functions of the mobile device 100, such as an application for supporting a voice call or video call, a web browser for accessing an Internet server, an MP3 application for playing digital sounds, an image viewer application for showing photo files, a video player application for playing video files, and the like. The program region may have a sensor operating program and a projector module operating program.

The sensor operating program may be loaded in the control unit 160 at the user's request or when the mobile device 100 is booted, and may include various routines for activating the sensor unit 110 and for collecting and applying sensor signals produced in the sensor unit 110. The sensor operating program may include a control routine for activating or deactivating respective sensors of the sensor unit 110, a determination routine for determining the validity or not of sensor signals produced in the respective sensors, and a delivery routine for delivering sensor signals with valid values to the control unit 160.

The control routine may include a routine for activating or deactivating at least one sensor according to the type and state of a currently running application, and a routine for activating or deactivating at least one sensor according to various input signals created in the input unit 120, the touch screen 140 and the sensor unit 110. The control routine may include a routine for activating both a pressure detection sensor and a movement detection sensor when the projector module 170 is activated, and a routine for deactivating the activated sensors when the projector module 170 is deactivated. The control routine may include a routine for deactivating the sensor unit 110 when a touch event occurs on the touch panel 143, and a routine for creating and delivering a command for deactivating the touch panel 143 when a predefined sensor signal is received from a specific sensor of the activated sensor unit 110.

The projector module operating program may be loaded in the control unit 160 at the user's request. The projector module operating program activates the projector module 170 according to an input signal received from the input unit 120 or the touch screen 140 and controls the output and play of various content according to additional input signals. The projector module operating program may include a routine for resizing selected content to adapt to the projector module 170 when the projector module 170 is activated and an input signal for playing selected content is received, a routine for outputting a menu screen to the projector module 170 according to a signal received from at least one of the input unit 120, the touch screen 140 and the sensor unit 110, and a routine for controlling a shift of a highlight and a selection of a menu item on the menu screen according to a signal received from the sensor unit 110.

The operation of the mobile device 100 based on the sensor operating program and the projector module operating program will be described later with reference to drawings.

The data region stores data created while the mobile device 100 is used. When the display unit 141 forms the touch screen 140 together with the touch panel 143, the data region may store the user's input received from the touch screen 140. The data region may store various content that may be outputted through the projector module 170 and the display unit 141. The data region may also buffer various sensor signals created in the sensor unit 110.

The projector module 170 may output, to a certain external target, data stored in the memory unit 150, data received through a particular function such as a digital broadcasting application, data received from various external electronic devices such as Personal Computer (PC), TV, Video Cassette Recorder (VCR), Digital Video Disc (DVD), camcorder, etc., that can be connected to the mobile device 100, and data generated while a specific application is running. The projector module 170 may be composed of an image input part, a lens, a focus driving motor, a projection angle driving motor, and a projection angle sensor. The image input part receives data from the control unit 160, and the lens projects the received data onto a certain target such as a display screen. The focus driving motor regulates the focus of the lens on the display screen. The projection angle driving motor regulates the projection angle of data to be projected. The projection angle sensor detects the projection angle of such data to be projected and then sends it to the control unit 160.

An image projected through the projector module 170 may be different from an image outputted on the display unit 141 in direction and in screen aspect ratio. The projector module 170 may regulate the screen aspect ratio of an image projected on the display screen according to a predefined value or depending on the user's input. The projector module 170 may output a menu screen as well as an image of content being played. A menu screen outputted through the projector module 170 may be different from a menu screen outputted on the display unit 141 in type or attribute. The menu screen on the display unit 141 may contain menu items for controlling a play and activation of the projector module 170.

The control unit 160 supports an initialization procedure for respective elements of the mobile device 100 by controlling a power-on. After initialization, the control unit 160 activates the sensor unit 110 so that the projector module 170 may operate based on the sensor unit 110. The control unit 160 may control signal flows between the respective elements in order to operate the projector module 170 based on a sensor mode.

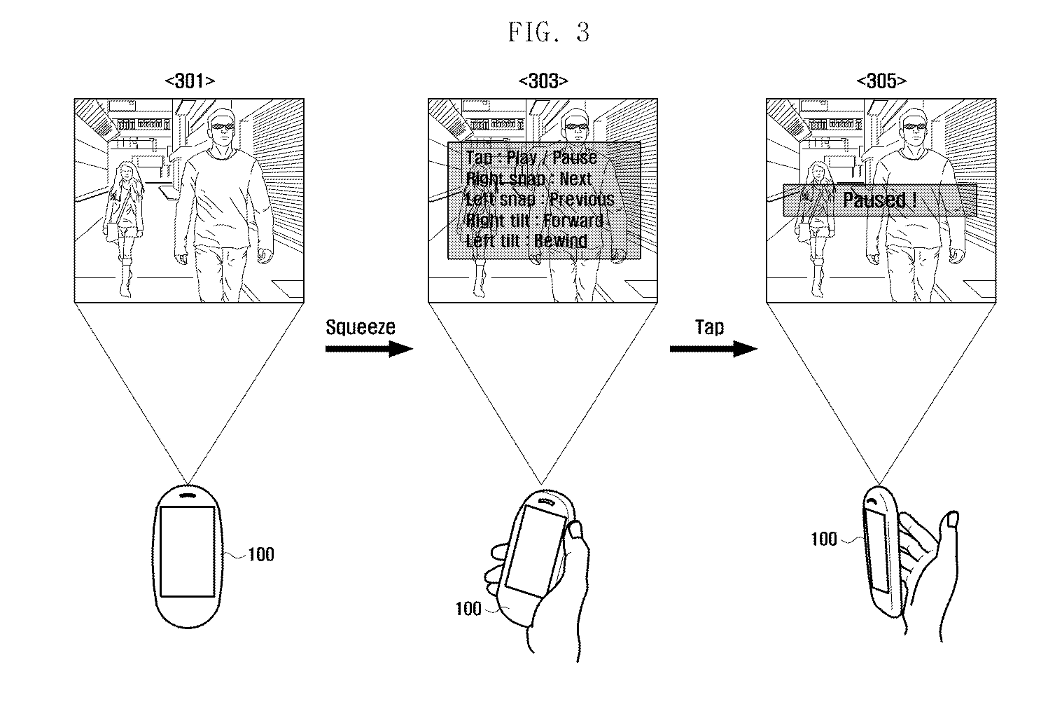

FIG. 2 is a block diagram which illustrates the configuration of a control unit according to an exemplary embodiment of the present invention.

Referring to FIG. 2, the control unit 160 may include a sensor signal collection unit 161, a functional performance unit 163, and a correction unit 165.

The sensor signal collection unit 161 controls the activation of the sensor unit 110 under the control of the functional performance unit 163, and monitors various sensors in the sensor unit 110 in order to check which sensor produces a signal. The sensor signal collection unit 161 sends information about the type of a signal-producing sensor to the functional performance unit 163, and also sends a signal of the sensor to the functional performance unit 163.

If the mobile device 100 has an acceleration sensor, the sensor signal collection unit 161 can detect a signal produced by a movement of the mobile device 100, such as a shake or snap motion. The sensor signal collection unit 161 can distinguish between a shake and a snap motion through variations in frequency generated by a movement of the mobile device 100. If a frequency curve varies smoothly and repeatedly, the sensor signal collection unit 161 interprets the motion as a shake motion. If a frequency curve varies suddenly one time, the sensor signal collection unit 161 interprets the motion as a snap motion. The sensor signal collection unit 161 may measure a tilt of the mobile device 100 through an acceleration sensor.

If the mobile device 100 has a gyro sensor, the sensor signal collection unit 161 may detect a signal produced by a shift in direction, such as a tilt, of the mobile device 100. If the mobile device 100 has a vibration sensor, the sensor signal collection unit 161 may detect a signal produced by a vibration of the mobile device 100 caused by a swing or external impact. If the mobile device 100 has a pressure sensor, the sensor signal collection unit 161 may detect a signal produced by a pressure applied to the mobile device 100 from the outside. By using a pressure sensor, the sensor signal collection unit 161 can know whether the user grasps the mobile device 100 and how much force is applied by a grasp. The sensor signal collection unit 161 may send such detected signals of respective sensors to the functional performance unit 163.

The functional performance unit 163 determines the type of a specific sensor to be activated, depending on a current state of the mobile device 100, and sends a signal for activating the specific sensor to the sensor signal collection unit 161. The functional performance unit 163 receives a sensor signal from the specific sensor activated by the sensor signal collection unit 161 and, based thereon, controls the performance of various functions of the mobile device 100. For example, the functional performance unit 163 may enable a pressure sensor to be activated when the projector module 170 is activated according to a user's input, and then output a menu screen through the projector module 170 when receiving a sensor signal more than a predefined value from the pressure sensor. Controlling the projector module 170 by the functional performance unit 163 will be described later with reference to drawings.

The correction unit 165 corrects an output while the functional performance unit 163 outputs through the projector module 170 various content stored in the memory unit 150 and various user interfaces offered by the mobile device 100. Since the project module 170 is disposed at one side of the mobile device 100, the user manipulates the projector module 170 while grasping the mobile device 100. As a result, an image being outputted through the projector module 170 may often tremble or tilt due to a user's movement. The correction unit 165 stabilizes the output image by correcting such trembling or tilting of the output image. This will be described later with reference to drawings.

The mobile device 100 typically supports a mobile communication function and, in this case, may further include an RF unit. Normally the RF unit establishes necessary communication channels under the control of the control unit 160. The RF unit forms a voice call channel, a video call channel, and a data communication channel with a mobile communication system. The RF unit may include an RF transmitter that up-converts the frequency of a signal to be transmitted and amplifies the signal, and an RF receiver that amplifies a received signal with low-noise and down-converts the frequency of the signal. Content received through the RF unit may be directly outputted to the projector module 170 according to the user's manipulation. The control unit 160 may resize such content to adapt for the screen aspect ratio of the projector module 170. The control unit 160 may also enable the RF unit to receive and send content in response to sensor signals of the sensor unit 110.

As discussed hereinbefore, the mobile device 100 according to an exemplary embodiment of the present invention may control the playing of images outputted through the projector module 170 and also may control an output of menu screens, depending on the sensor unit 110. Accordingly, the user can use the mobile device 100 having the projector module 170 much more conveniently and easily.

A user interface that supports the operation of the projector module 170 based on the sensor unit 110 while the projector module 170 outputs a certain image is described below.

FIG. 3 is an example view which illustrates a user interface of a mobile device in accordance with an exemplary embodiment of the present invention.

Referring to FIG. 3, depending on the user's manipulations, the mobile device 100 selects specific content stored in the memory unit 150 and activates the projector module 170 in order to output an image of the selected content through the projector module 170. The mobile device 100 activates and controls a specific application required to play video content. When the selected video content is played, the mobile device 100 optimizes the video image to adapt for the screen aspect ratio and resolution that are set up in the projector module 170, and then outputs the optimized image through the projector module 170 as shown in the first screen 301. The mobile device 100 automatically initiates a sensor mode and then may activate at least one of sensors such as an acceleration sensor, a gyro sensor, a pressure sensor, a vibration sensor, and a geomagnetic sensor. The mobile device 100 may activate only one sensor (e.g., a pressure sensor) and activate some of the other sensors (e.g., an acceleration sensor, a touch sensor, etc.) when a specific sensor signal is received (e.g., when a pressure more than a given value is detected). The mobile device 100 may deactivate other sensors when a pressure sensor is activated, and then may selectively activate the other sensors when a given sensor signal is received from the pressure sensor.

When a specific sensor signal is received from the sensor unit 110 while the selected video is outputted through the projector module 170, the mobile device 100 may enable a particular function to be performed depending on the received sensor signal. For example, when a pressure more than a given value is detected through a pressure sensor, the sensor unit 110 may create a “squeeze” sensor signal and send the sensor signal to the control unit 160. The control unit 160 may output a menu screen corresponding to the received “squeeze” sensor signal through the projector module 170 as shown in the second screen example 303. Under the control of the control unit 160, the menu screen may overlap the video image being outputted through the projector module 170 or may be displayed with no video image outputted. In addition, the control unit 160 may continue to output the video content through the projector module 170 or may control the playing of the video content, depending on a user's setting or play schedule.

The menu screen may contain some items for a video play control and corresponding gesture types. For example, the menu screen may contain a “Play/Pause” item corresponding to a “Tap” gesture, a “Next” item (denoting a move to next content or a skip to a next frame position in a current video) corresponding to a “Right Snap” gesture, a “Previous” item (denoting a move to previous content or a return to a previous frame position in a current video) corresponding to a “Left Snap” gesture, a “Forward” item corresponding to a “Right Tilt” gesture, a “Rewind” item corresponding to a “Left Tilt” gesture, and the like. The menu screen may also contain other various menu items, such as items for regulating a screen aspect ratio or screen resolution. In order to support such menu items, the mobile device 100 may activate suitable sensors, such as an acceleration sensor, a piezoelectric sensor, a pressure sensor or a touch sensor, for detecting a tap, snap, or tilt gesture. If there is no touch sensor, the mobile device 100 may utilize instead the touch screen 140.

When the user makes a tapping gesture on the touch screen or a specially equipped touch sensor in the second screen example 303, the mobile device 100 performs a pause function to stop playing a current video for a short time as shown in the third screen example 305. The control unit 160 may output a message indicating a currently performed function, namely a currently selected menu item, through the projector module 170.

The correction unit 165 of the mobile device 100 may not perform an image correction such as a tilt correction or a trembling correction while the projector module 170 outputs a video as shown in the first screen example 301. Instead the correction unit 165 may perform an image correction when a specific sensor signal (i.e., a “squeeze” sensor signal) is received. The correction unit 165 may activate a sensor for detecting a trembling or tilt of an image outputted through the projector module 170. For example, the correction unit 165 may activate an image sensor, detect a trembling or tilt of an image outputted through the projector module 170, and correct the image output. The correction unit 165 may also activate an acceleration sensor or a geomagnetic sensor, detect a trembling or tilt of the mobile device 100 itself, and correct the image output. When image trembling occurs, the correction unit 165 may recognize a trembling pattern and then regulate the image output contrary to the pattern. When an image tilt occurs, the correction unit 165 may detect a tilt angle based on a predefined image output standard and then revise the detected tilt angle.

The menu screen may not always be outputted through the projector module 170. The control unit 160 may not output a menu screen even though a specific sensor signal is received. In this case, the user may have been aware of predefined gestures and, based thereon, manipulate the mobile device 100. Accordingly, the projector module 170 may output only an image of a selected video and then perform a video play control under the control of the control unit 160 depending on a sensor signal of the sensor unit 110.

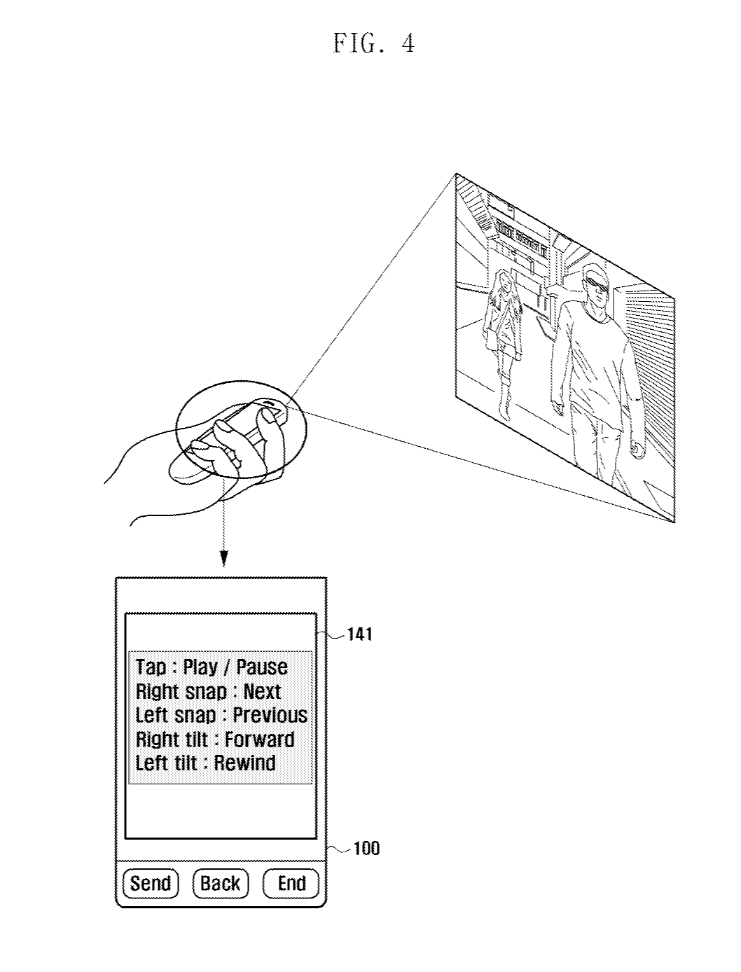

FIG. 4 is an example view which illustrates a user interface of a mobile device in accordance with another exemplary embodiment of the present invention.

Referring to FIG. 4, depending on the user's manipulations, the mobile device 100 may play selected video content and then output a video through the projector module 170. The mobile device 100 automatically initiates a sensor mode and then may activate at least one of the sensors of the sensor unit 110. For example, the mobile device 100 may activate a piezoelectric sensor of the sensor unit 110. The mobile device 100 may control an audio data output through the audio processing unit 130 when the selected video content contains audio data. Depending on the user's setting, the mobile device 100 may output the same video content on the display unit 141 as outputted through the projector module 170. Alternatively, depending on a user's setting, the mobile device 100 may cut off power to the display unit 141.

The user may make a certain gesture for a video content control while seeing the video content outputted through the projector module 170. For example, the user may apply a pressure more than a predefined value to the mobile device 100. The sensor unit 110 may produce a “squeeze” sensor signal corresponding to the applied pressure and send the sensor signal to the control unit 160.

Depending on the received sensor signal, the control unit 160 may output on the display unit 141 a menu screen or control guide page for a play control of video content outputted through the projector module 170. If the display unit 141 is powered-off, the mobile device 100 may supply power to the display unit 141 and then output the menu screen or control guide page. The mobile device 100 may also activate the touch panel 143 as well as the display unit 141 to support functions of the touch screen 140. The mobile device 100 may not output the menu screen or control guide page through the projector module 170.

When the menu screen is outputted on the display unit 141, the mobile device 100 may activate a specific sensor required for a video play control offered in the menu screen. For example, the mobile device 100 may activate a touch sensor or piezoelectric sensor for detecting a tap sensor signal, an acceleration sensor for detecting a snap sensor signal, and an acceleration sensor or geomagnetic sensor for detecting a tilt sensor signal. Thereafter, when the user makes one of gesture types offered in the menu screen, the mobile device 100 may collect a sensor signal based on the user's gesture and then perform a given video play control.

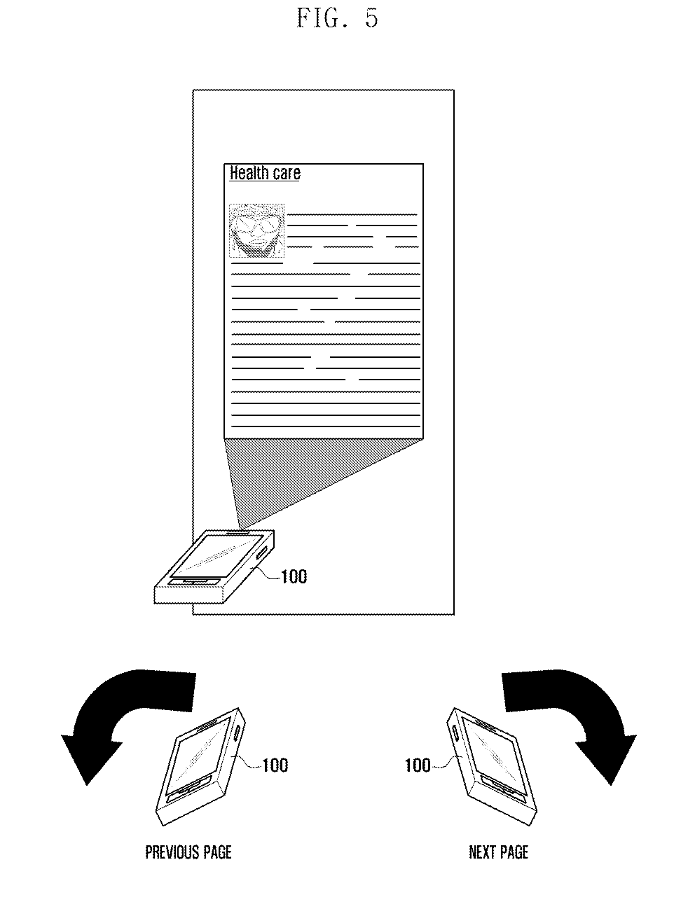

FIG. 5 is an example view which illustrates a user interface of a mobile device in accordance with still another exemplary embodiment of the present invention.

Referring to FIG. 5, when an input signal for outputting certain text stored in the memory unit 150 through the projector module 170 is created, the mobile device 100 may output an image corresponding to the selected text through the projector module 170. The mobile device 100 may optimize the text image to adapt for the screen aspect ratio and resolution that are set up in the projector module 170, and output the text image through the projector module 170.

When the text image is outputted through the projector module 170, the mobile device 100 may enter into a sensor mode and activate a specific sensor of the sensor unit 110. For example, the mobile device 100 may activate at least one of an acceleration sensor and a geomagnetic sensor.

After a specific sensor is activated, the user may make a certain gesture for a sensor unit based control of the text image outputted through the projector module 170. For example, when the text is composed of several pages, the user may make a given gesture to output a desired page. As shown in FIG. 5, the user may make a leftward tilt gesture to see the previous page and also make a rightward tilt gesture to see the next page. The mobile device 100 may turn over text pages depending on a leftward tilt sensor signal or a rightward tilt sensor signal produced by the user's gesture.

Alternatively, when an acceleration sensor is activated to detect a snap sensor signal, the user may make a leftward or rightward snap gesture with the mobile device 100 grasped. The mobile device 100 may detect a leftward or rightward snap sensor signal and, based thereon, perform a turn-over of pages. According to another exemplary embodiment of the present invention, when still images such as photos are outputted through the projector module 170, the mobile device 100 may control the projector module 170 in a manner according to an exemplary embodiment of the present invention.

In addition, the activation of a specific sensor may not always depend on the type of content. The mobile device 100 may activate a specific type of sensor only, depending on particular content or end-user function selected by the user among content stored in the memory unit 150, content received from the outside, and various end-user functions offered by the mobile device 100. Accordingly, the mobile device 100 may prevent an unnecessary activation of sensors and support an optimal utilization of sensors in operating the projector module 170.

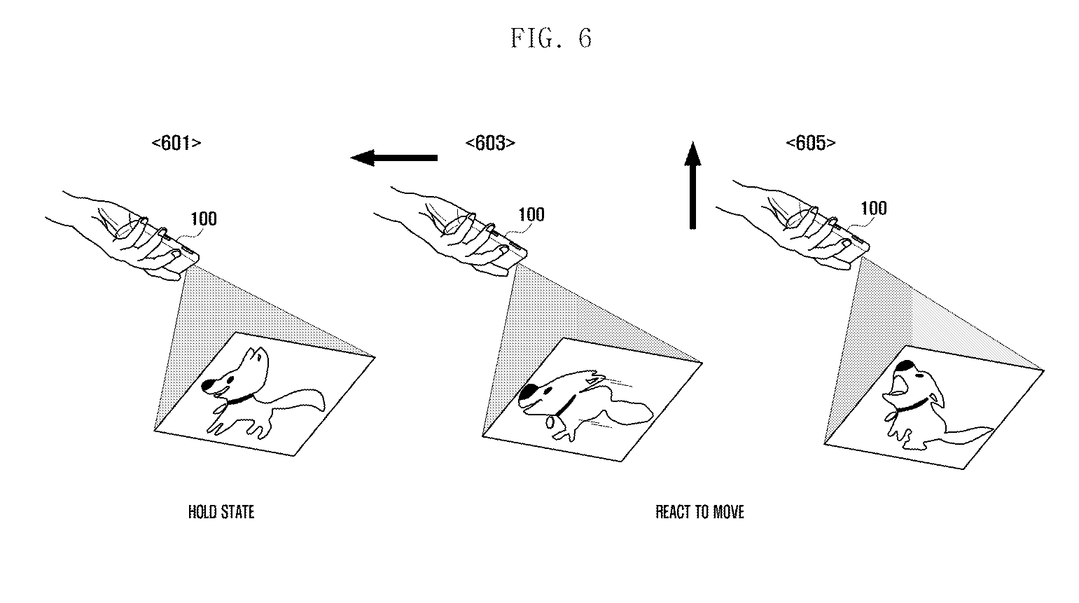

FIG. 6 is an example view which illustrates a user interface of a mobile device in accordance with an exemplary embodiment of the present invention.

Referring to FIG. 6, at the user's request, the mobile device 100 may output a certain image depending on the activation of predefined specific content through the projector module 170. For example, when a certain game function such as “My pet” is performed, an input signal may be created to output a related avatar such as “dog” through the projector module 170. The mobile device 100 may output an avatar image through the projector module 170. The mobile device 100 may automatically initiate a sensor mode and then activate at least one sensor of the sensor unit 110, such as an acceleration sensor. If no sensor signal is received from the activated sensor, the mobile device 100 may regard a current state as a hold state and then output the avatar image in a stationary state as shown in the first screen example 601.

When the user moves the mobile device 100 in a specific direction, the mobile device 100 may detect a sensor signal caused by the user's motion. If the user makes a leftward snap or shake motion, the mobile device 100 may detect a corresponding sensor signal and then control the movement of avatar depending on the detected sensor signal. For example, as shown in the second screen 603, the mobile device 100 may control the avatar image so that the avatar image may move in a direction of the sensor signal. This control for the avatar image may continue while the sensor signal is generated.

Additionally, when the user moves the mobile device 100 upward against the ground, the mobile device 100 may detect an upward snap or shake sensor signal and then control the movement of the avatar depending on the detected sensor signal. For example, as shown in the third screen example 605, the mobile device 100 may control the avatar image so that a dog avatar may raise its chin or alternatively so that the dog avatar may jump up.

As discussed hereinbefore, the mobile device 100 according to an exemplary embodiment of the present invention may perform a real-time control for an image outputted through the projector module 170, depending on a sensor signal received from the sensor unit 110 while various end-user functions of the mobile device 100 are operated.

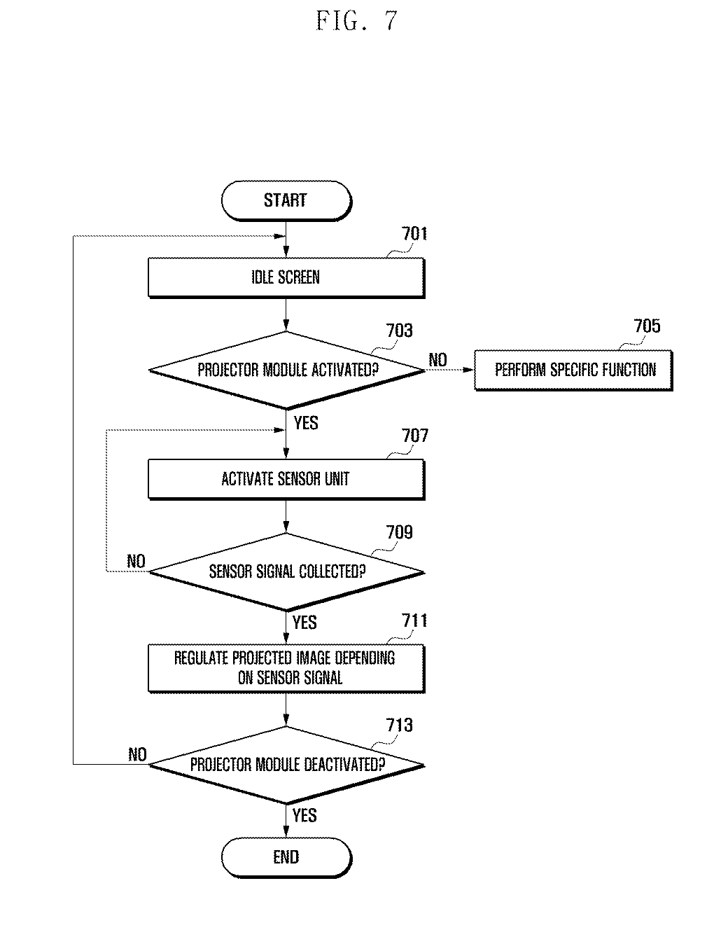

FIG. 7 is a flow diagram which illustrates a method for operating a mobile device having a projector module in accordance with an exemplary embodiment of the present invention.

Referring to FIG. 7, when power is supplied, the control unit 160 of the mobile device 100 performs a booting process and also initializes the respective elements. The control unit 160 outputs a predefined idle screen on the display unit 141 in step 701.

The control unit 160 determines whether an input signal for activating the projector module 170 is created in step 703. When the user selects a specific menu item or key for activating the projector module 170, the control unit 160 may determine that the projector module 170 is activated.

If the created input signal is unrelated to the activation of the projector module 170, the control unit 160 may perform a specific end-user function corresponding to the input signal, such as a file play function, a call function, a file search function, and the like in step S705.

If the created input signal is related to the activation of the projector module 170 in step S703, the control unit 160 may enter into a sensor mode and also activate the sensor unit 110 in step S707. In this step, the control unit 160 may activate at least one of various sensors included in the sensor unit 110 according to a predefined condition. When the user selects specific content to be outputted through the projector module 170, the control unit 160 may determine specific sensors of the sensor unit 110 according to the type of selected content and then activate the specific sensors. For example, when the user requests output of certain video content through the projector module 170, the control unit 160 may activate a sensor for detecting a pressure or a sensor for detecting a tilt, a shake, or a tap. In this case, the control unit 160 may activate first a pressure detection sensor such as a piezoelectric sensor and then, if a sensor signal caused by a pressure more than a given value is received, activate at least one of the other sensors, such as an acceleration sensor, a geomagnetic sensor, and a touch sensor. When the output of images corresponding to slide-type content is requested by a user, the control unit 160 may activate only a sensor for detecting a tilt or a shake.

The control unit 160 determines whether a sensor signal is collected in step 709. If no sensor signal is collected, the control unit 160 may return to the aforesaid step 707, keep the activated sensor operating, and continue to output an image of the selected content through the projector module 170.

On the other hand, if a given sensor signal is collected in step 709, the control unit 160 may regulate a projected image, depending on the sensor signal in step 711. The control unit 160 may output through the projector module 170 a menu screen or control guide page that allows a sensor unit based control of a currently outputted image according to the sensor signal. The control unit 160 may output such a menu screen or control guide page on the display unit 141. This control based on the sensor unit 110 for the projector module 170 may be applied to any other controls for video content or for broadcast content. In case of broadcast content, the menu screen or control guide page may be a channel screen or channel guide that contains information about a control method of the sensor unit 110 for a channel change.

Occasionally the control unit 160 may not output the menu screen or control guide page to at least one of the projector module 170 and the display unit 141, and directly perform an image output control depending on the sensor signal. For example, when a leftward snap sensor signal or a leftward tilt sensor signal is received, the control unit 160 may output the previous image. This control based on the sensor unit 110 may be applied when the projector module 170 outputs text images of several pages or outputs several photo images, for example.

After applying the sensor signal to currently activated content to perform a particular function, the control unit 160 may output a resultantly changed image through the projector module 170. This control based on the sensor unit 110 may be applied to a game function based on the sensor unit 110, an avatar regulation function based on the sensor unit 110, etc.

The control unit 160 determines whether to deactivate the projector module 170 in step 713. If the projector module 170 continues to operate, the control unit may return to the initial step 701.

As discussed hereinbefore, the operation method of the mobile device 100 having the projector module 170 according to exemplary embodiments of the present invention may support various functions required for an image control based on the sensor unit 110. Accordingly, depending on the user's simple manipulation, the images outputted through the projector module 170 can be easily controlled.

The mobile device 100 according to an exemplary embodiment of the present invention may essentially or selectively include other elements, such as a short range communication module, a location based service module such as a Global Positioning System (GPS) module, a camera module, a wired or wireless data transmission interface, an Internet access module, a digital broadcast receiving module, and the like. According to a digital convergence tendency today, such elements may be varied, modified and improved in various ways, and other elements equivalent to the above elements may be additionally or alternatively equipped in the mobile device 100. As will be understood by those skilled in the art, some of the above-mentioned elements in the mobile device may be omitted or replaced with another.

Exemplary embodiments of the present invention may be applied to all kinds of electronic devices having at least one sensor and a projector module. For example, the mobile device 100 may include many types of mobile communication terminals based on various communication protocols, such as Portable Multimedia Player (PMP), a digital broadcasting player, a Personal Digital Assistant (PDA), a music player (e.g., an MP3 player), a portable game console, a smart phone, a tablet PC, and the like.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile device comprising:
a projector module for projecting an image onto an external surface;
a sensor unit including at least one sensor to be activated when the projector module is activated, for detecting a state of the mobile device, and for outputting a sensor signal; and
a control unit for controlling the image projected through the projector module, based on the sensor signal.

2. The mobile device of claim 1, wherein the sensor unit comprises at least one of:
a sensor for detecting a pressure applied to the mobile device;
a sensor for detecting a tilt or shake of the mobile device; and
a sensor for detecting a touch on a specific region of the mobile device.

3. The mobile device of claim 2, wherein the control unit activates at least one of the sensors of the sensor unit when the projector module is activated, and activates the other sensors when a given sensor signal is received from the at least one activated sensor.

4. The mobile device of claim 2, wherein the control unit activates the pressure detecting sensor when the projector module is activated, and activates at least one of the tilt or shake detecting sensor and the touch detecting sensor when a given sensor signal is received from the pressure detecting sensor.

5. The mobile device of claim 1, wherein the control unit includes:
a sensor signal collection unit for collecting the sensor signal created in the sensor unit;
a functional performance unit for performing the control of the image, based on the sensor signal; and
a correction unit for correcting a trembling or tilt of the image projected through the projector module or a trembling or tilt of the projector module.

6. The mobile device of claim 1, wherein the control unit projects through the projector module at least one of a menu screen and a control guide page for assisting the control of the image outputted through the projector module, depending on the sensor signal.

7. The mobile device of claim 1, wherein when the image projected through the projector module is received through a broadcast receiving module, the control unit projects through the projector module at least one of a menu screen and a control guide page for assisting the control of the image.

8. The mobile device of claim 1, further comprising:
a display unit for outputting at least one of a menu screen, a control guide page, a channel screen, and a channel guide page for assisting the control of the image projected through the projector module, based on the sensor signal.

9. The mobile device of claim 1, further comprising at least one of:
a memory unit for storing content projected through the projector module; and
an input unit for creating an input signal for selecting the content projected through the projector module or a particular end-user function.

10. The mobile device of claim 9, wherein the control unit activates at least one of the sensors of the sensor unit based on a type of the selected content or end-user function.

11. The mobile device of claim 1, wherein the control unit applies the sensor signal to a currently running application and then projects through the projector module the image changed by operation of the current application to which the sensor signal is applied.

12. A method of operating a mobile device having a projector module, the method comprising:
activating at least one sensor of a sensor unit when the projector module of the mobile device is activated;
projecting content onto an external surface via the projector module; and
when the at least one enabled sensor generates a sensor signal, controlling at least one of the projection of the image and a displaying of data on a display unit of the mobile device, based on the sensor signal.

13. The method of claim 12, wherein the activating of the sensor unit comprises at least one of:
activating a sensor for detecting pressure applied to the mobile device;
activating a sensor for detecting a tilt or shake of the mobile device; and
activating a sensor for detecting a touch on a specific region of the mobile device.

14. The method of claim 13, wherein the activating of the sensor unit comprises:
activating at least one of the sensors;
receiving a given sensor signal from the at least one activated sensor; and
activating the other sensors of the sensor unit.

15. The method of claim 13, wherein the activating of the sensor unit comprises:
activating the pressure detecting sensor; and
activating at least one of the tilt or shake detecting sensor and the touch detecting sensor when a given sensor signal is received from the pressure detecting sensor.

16. The method of claim 12, further comprising:
detecting a trembling or tilt of the image projected through the projector module or a trembling or tilt of the projector module; and
correcting the trembling or tilt.

17. The method of claim 12, wherein the performing of the output control comprises at least one of:
projecting through the projector module at least one of a menu screen and a control guide page for assisting the control of the image projected through the projector module, based on the sensor signal; and
outputting, on a display unit, at least one of the menu screen and the control guide page for assisting the control of the image projected through the projector module, based on the sensor signal.

18. The method of claim 12, wherein the performing of the output control comprises at least one of:
when the image projected through the projector module is received through a broadcast receiving module, projecting through the projector module at least one of a menu screen and a control guide page for assisting the control of the image, based on the sensor signal; and
outputting on a display unit at least one of the menu screen and the control guide page for assisting the control of the image projected through the projector module, based on the sensor signal.

19. The method of claim 12, further comprising:
selecting at least one of content stored in a memory unit, content received from an outside source, and an end-user function offered by the mobile device,
wherein the activating of the sensor unit includes activating at least one of the sensors of the sensor unit according to a type of the selected content or the end-user function.

20. The method of claim 12, wherein the performing of the output control comprises:
applying the sensor signal to a currently running application; and
projecting through the projector module the image changed by operation of the current application to which the sensor signal is applied.
